(19) United States
(12) Patent Application Publication
(10) Pub. No.: US 2024/0047112 A1
(43) Pub. Date: Feb. 8, 2024

(54) CYLINDRICAL MULTIPOLE MAGNET AND COMPOSITE MATERIAL

(71) Applicant: NICHIA CORPORATION, Anan-shi (JP)

(72) Inventors: Rie YOSHIDA, Anan-shi (JP); Daichi ITAMI, Anan-shi (JP); Masahiro ABE, Tokushima-shi (JP); Kuniyasu KAWAMURA, Anan-shi (JP); Takayuki YANO, Tokushima-shi (JP); Muneo YAMAMOTO, Tokushima-shi (JP)

(73) Assignee: NICHIA CORPORATION, Anan-shi (JP)

(21) Appl. No.: 18/366,601

(22) Filed: Aug. 7, 2023

(30) Foreign Application Priority Data
Aug. 8, 2022 (JP) 2022-126296

(51) Int. Cl. H01F 7/02; H01F 1/059

(52) U.S. Cl. CPC H01F 7/021; H01F 1/059

(57) ABSTRACT

A cylindrical multipole magnet having an inner peripheral surface and an outer peripheral surface and having N- and S-poles alternately and continuously in a circumferential direction. A surface magnetic flux density of the outer peripheral surface is at least 0.2 times a surface magnetic flux density of the inner peripheral surface. The cylindrical multipole magnet contains an anisotropic rare earth magnetic powder and a resin, with a filling ratio of the anisotropic rare earth magnetic powder being at least 50 vol % but not higher than 65 vol % with respect to a total volume of the anisotropic rare earth magnetic powder and the resin.

### CROSS-REFERENCE TO RELATED PATENT APPLICATION

This application claims priority to Japanese Patent Application No. 2022-126296 filed on Aug. 8, 2022. The disclosure of Japanese Patent Application No. 2022-126296 is hereby incorporated by reference in its entirety.

### BACKGROUND

The present disclosure relates to a cylindrical multipole magnet and a composite material.

Cylindrical multipole magnets are used in various applications such as small motors. For example, JP H5-152122 A discloses a cylindrical multipole magnet produced with a cobalt-based bonded magnet.

However, the cylindrical multipole magnet disclosed in JP H5-152122 A is not sufficiently oriented to provide a high magnetic flux density.

### SUMMARY

Certain embodiments of the present disclosure aim to provide a cylindrical multipole magnet with a higher surface magnetic flux density.

Exemplary embodiments of the present disclosure relate to a cylindrical multipole magnet, having an inner peripheral surface and an outer peripheral surface and having N- and S-poles alternately and continuously in a circumferential direction, wherein a surface magnetic flux density of the outer peripheral surface is at least 0.2 times a surface magnetic flux density of the inner peripheral surface, and wherein the cylindrical multipole magnet contains an anisotropic rare earth magnetic powder and a resin, with a filling ratio of the anisotropic rare earth magnetic powder being at least 50 vol % but not higher than 65 vol % with respect to a total volume of the anisotropic rare earth magnetic powder and the resin.

The above embodiments can provide a cylindrical multipole magnet with a higher surface magnetic flux density.

### BRIEF DESCRIPTION OF DRAWINGS

FIG. 1A shows an external view of a composite material provided with a back yoke on the inner peripheral side according to exemplary embodiments of the present disclosure.

FIG. 1B shows an external view of a composite material provided with a back yoke on the outer peripheral side according to exemplary embodiments of the present disclosure.

FIG. 2 shows a cross-sectional view of an injection molding mold used to produce cylindrical multipole magnets (the number of magnetic poles: 48) according to exemplary embodiments of the present disclosure.

FIG. 3 shows a cross-sectional view of a magnetizing yoke used for the cylindrical multipole magnets according to the exemplary embodiments of the present disclosure.

FIG. 4 shows a cross-sectional view of an injection molding mold used to produce the cylindrical multipole magnets of comparative examples.

FIG. 5 shows a cross-sectional view of a magnetizing yoke used for the cylindrical multipole magnets of the comparative examples.

### DETAILED DESCRIPTION

Embodiments of the present disclosure are described in detail below. The following embodiments, however, are intended as examples to embody the technical idea of the present disclosure and are not intended to limit the scope of the present disclosure to the following embodiments. As used herein, the term “step” encompasses not only an independent step but also a step that may not be clearly distinguished from other steps, as long as a desired object of the step is achieved. Moreover, numerical ranges indicated using “to” refer to ranges including the numerical values before and after “to” as the minimum and maximum, respectively.

### Cylindrical Multipole Magnet

A cylindrical multipole magnet according to the present embodiments has an inner peripheral surface and an outer peripheral surface and has N- and S-poles alternately and continuously in a circumferential direction,
wherein a surface magnetic flux density of the outer peripheral surface is at least 0.2 times a surface magnetic flux density of the inner peripheral surface, and
wherein the cylindrical multipole magnet contains an anisotropic rare earth magnetic powder and a resin, with a filling ratio of the anisotropic rare earth magnetic powder being at least 50 vol % but not higher than 65 vol % with respect to a total volume of the anisotropic rare earth magnetic powder and the resin.

The difference between the outer diameter and the inner diameter (which is twice the thickness) of the cylindrical multipole magnet is preferably at least 1.0 mm but not more than 8.0 mm, more preferably at least 2.0 mm but not more than 6.0 mm, still more preferably at least 2.5 mm but not more than 6.0 mm. A difference of not more than 8.0 mm tends to allow the cylindrical multipole magnet to have a thin body to improve the orientation of the magnetic powder. A difference of at least 1.0 mm tends to improve the strength of the cylindrical multipole magnet to reduce cracks in the molded article and also tends to ensure fluidity during the formation of the magnet, resulting in an improved orientation ratio. Moreover, the outer diameter is not limited, but it is preferably at least 15 mm but not more than 100 mm, more preferably at least 16 mm but not more than 50 mm.

The length of the cylindrical multipole magnet is not limited, but it is preferably at least 3 mm but not more than 80 mm, more preferably at least 5 mm but not more than 30 mm. If the length is more than 80 mm, filling or orientation tends to deteriorate at sites far from the gate through which a mixture of the magnetic powder and the resin is poured during injection molding. If the length is less than 3 mm, the amount of magnetic flux on the working surface may be reduced.

The cylindrical multipole magnet is magnetized to have N- and S-poles alternately and continuously in the circumferential direction. The number of magnetic poles is not limited, but it is preferably at least 16 but not more than 64, more preferably at least 24 but not more than 64, still more preferably at least 36 but not more than 64. The number of magnetic poles varies depending on the intended application. When the number of magnetic poles is at least 16, the cylindrical multipole magnet may provide a higher effect in improving the surface magnetic flux density, while when the number of magnetic poles is not more than 64, at least a certain spacing between the orientation magnets can be ensured to provide a larger orientation field, resulting in a bonded magnet having a higher surface magnetic flux density.

The cylindrical multipole magnet contains an anisotropic rare earth magnetic powder and a resin, with a filling ratio of the anisotropic rare earth magnetic powder of at least 50 vol % but not higher than 65 vol %, preferably at least 50 vol % but not higher than 60 vol %, more preferably at least 50 vol % but not higher than 58 vol %, still more preferably at least 51 vol % but not higher than 56 vol % with respect to the total volume of the anisotropic rare earth magnetic powder and the resin. If the filling ratio of the anisotropic rare earth magnetic powder is lower than 50 vol % with respect to the total volume of the anisotropic rare earth magnetic powder and the resin, it may be difficult to mold a thin multipole bonded magnet with a small difference between the outer and inner diameters. A filling ratio of higher than 65 vol % tends to reduce orientation during the formation of the multipole bonded magnet, thereby reducing the surface magnetic flux density of the resulting bonded magnet.

The cylindrical multipole magnet has a surface magnetic flux density also on the outer peripheral side. The expression “has a surface magnetic flux density also on the outer peripheral side” means that, when the surface magnetic flux densities on the outer and inner peripheral sides of the cylindrical multipole magnet provided with no back yoke are measured, the surface magnetic flux density on the outer peripheral side is at least 0.2 times, preferably at least 0.4 times, more preferably at least 0.5 times, still more preferably at least 0.8 times, particularly preferably at least 0.95 times the surface magnetic flux density on the inner peripheral side. Moreover, the surface magnetic flux density on the outer peripheral side may be at most 1.2 times, at most 1.1 times, or at most 1.0 times the surface magnetic flux density on the inner peripheral side. The cylindrical multipole magnet having a surface magnetic flux density also on the outer peripheral side as described above can also be used as a magnet having a working surface on the outer peripheral side, and may serve as a composite material with higher magnetic properties, particularly when provided with a back yoke. The surface magnetic flux densities on the outer and inner peripheral sides can be measured as described later.

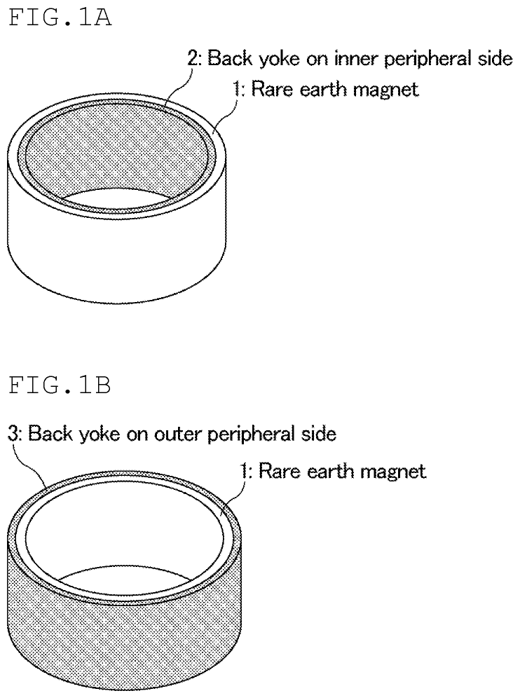

The cylindrical multipole magnet can be used as a composite material when a back yoke is fixed to the inner peripheral surface or outer peripheral surface of the cylindrical multipole magnet. When the inner peripheral surface or outer peripheral surface of the cylindrical multipole magnet according to the present embodiments is fixed with a back yoke, the surface magnetic flux density on the target working surface may be increased. FIG. 1A and FIG. 1B show external views of composite materials provided with a back yoke on the inner and outer peripheral sides, respectively, according to exemplary embodiments of the present disclosure. Although the material of the back yoke is not limited, examples of the material include stainless steel including SUS403 and SS materials (general structural rolled steel materials) including SS400. From the standpoint of the effect of suppressing corrosion, the surface of the back yoke is preferably plated with zinc or other material. The back yoke may have an annular shape. The back yoke provided on the inner peripheral side may have a cylindrical shape. The back yoke provided on the outer peripheral side may have an inner diameter that is larger than the outer diameter of the cylindrical multipole magnet. Moreover, the thickness of the back yoke is not limited, but it is preferably at least 0.5 mm but not more than 10 mm, more preferably at least 1 mm but not more than 5 mm.

The cylindrical multipole magnet contains an anisotropic rare earth magnetic powder and a resin. Examples of the anisotropic rare earth magnetic powder include SmFeN-based, NdFeB-based, and SmCo-based magnetic powders. Preferred among these are SmFeN-based magnetic powders that are nitrides containing samarium and iron. SmFeN-based magnetic powders may generally be represented by Sm₂Fe₁₇N₃. SmFeN-based magnetic powders have a stronger magnetic force than ferrite-based magnetic powders and may be used even in a relatively small amount to generate a high magnetic force. Moreover, SmFeN-based magnetic powders have a smaller particle size than other rare earth-based magnetic powders such as NdFeB-based and SmCo-based magnetic powder and thus are suitable as fillers to be used in the base material resin. Another characteristic is that they are rust-resistant.

### Anisotropic Rare Earth Magnetic Powder

The exothermic onset temperature of the anisotropic rare earth magnetic powder may be adjusted to 160° C. or higher, preferably 170° C. or higher, more preferably 200° C. or higher, still more preferably 210° C. or higher, particularly preferably 260° C. or higher. The exothermic onset temperature of the anisotropic rare earth magnetic powder, when coated with a phosphate, represents the overall evaluation of the density, thickness, oxidation resistance, etc. of the phosphate coating. When the exothermic onset temperature is 170° C. or higher, a high coercive force can be obtained. Moreover, when the magnetic powder having an exothermic onset temperature of higher than 210° C. is used to produce a bonded magnet, the bonded magnet tends to have much higher water resistance. The water resistance may be further improved when the exothermic onset temperature is 260° C. or higher. Here, the exothermic onset temperature can be measured with a differential scanning calorimeter (DSC).

The anisotropic rare earth magnetic powder used in the cylindrical multipole magnet preferably has an average particle size of 10 μm or less, more preferably at least 1 μm but not more than 5 μm. When the average particle size is 10 μm or less, irregularities, cracks, etc. are less likely to occur on the surface of the product, resulting in an excellent appearance; additionally, cost reduction may be achieved. An average particle size of more than 10 μm may lead to irregularities, cracks, etc. on the surface of the product, resulting in a poor appearance. Moreover, an average particle size of less than 1 μm can lead to a high cost of the magnetic powder, which is unfavorable in terms of cost reduction. The average particle size of the anisotropic rare earth magnetic powder is defined as the particle size corresponding to the 50th percentile of the cumulative undersize particle size distribution by volume determined by laser diffraction. Moreover, the ratio of the 90th percentile particle size (D90) to the 10th percentile particle size (D10) in the cumulative particle size distribution by volume (D90/D10) is preferably 4.5 or less, more preferably 4 or less, particularly preferably 3.5 or less. A particle size distribution D90/D10 of 4.5 or less may lead to better fluidity during the formation of even a thin-shaped magnet, resulting in a bonded magnet having better orientation properties and a higher orientation ratio.

### Method of Producing SmFeN-Based Anisotropic Magnetic Powder

The SmFeN-based anisotropic magnetic powder may be produced by, for example, a method including:
mixing a solution containing metals such as Sm and Fe with a precipitant to obtain a precipitate containing metals such as Sm and Fe (precipitation step);
firing the precipitate to obtain an oxide containing metals such as Sm and Fe (oxidation step);
heat-treating the oxide in a reducing gas-containing atmosphere to obtain a partial oxide (pretreatment step);
reducing the partial oxide (reduction step); and
nitriding alloy particles obtained in the reduction step (nitridation step).

The anisotropic magnetic powder produced by the above-mentioned method may be directly used, but it is preferably subjected to the following further treatment(s):
(1) a phosphate treatment including adding an inorganic acid to a slurry containing the anisotropic magnetic powder, water, and a phosphate compound to adjust the pH of the slurry to at least 1 but not more than 4.5 to obtain an anisotropic magnetic powder having a surface coated with a phosphate (phosphate treatment step accompanied by pH adjustment), and/or
(2) an oxidation treatment including heat-treating the phosphate-coated anisotropic magnetic powder at a temperature of at least 200° C. but not higher than 250° C. in an oxygen-containing atmosphere (oxidation step).

### Phosphate Treatment Step

In the phosphate treatment step, an inorganic acid may be added to a slurry containing the anisotropic magnetic powder, water, and a phosphate compound to adjust the pH of the slurry to at least 1 but not more than 4.5, thereby obtaining an anisotropic magnetic powder having a surface coated with a phosphate. The phosphate-coated anisotropic magnetic powder can be formed by reacting the metal component (for example, iron, samarium) in the anisotropic magnetic powder with the phosphate component in the phosphate compound to precipitate a phosphate (for example, iron phosphate, samarium phosphate) on the surface of the anisotropic magnetic powder. Although the adjustment of the pH of the slurry is optional and coating with a phosphate may be achieved without pH adjustment, pH adjustment can increase phosphate precipitation compared to no pH adjustment, resulting in a phosphate-coated anisotropic magnetic powder having a thicker coating portion. Moreover, by using water as a solvent, a phosphate with a smaller particle size can be precipitated than when an organic solvent is used as a solvent, so that the resulting phosphate-coated anisotropic magnetic powder has a denser coating portion.

The slurry containing the anisotropic magnetic powder, water, and a phosphate compound may be prepared by any method. For example, the slurry may be obtained by mixing the anisotropic magnetic powder with an aqueous phosphate solution containing a phosphate compound and water as a solvent. The amount of the anisotropic magnetic powder in the slurry is, for example, at least 1% by mass but not more than 50% by mass. In view of productivity, the amount is preferably at least 5% by mass but not more than 20% by mass. The amount of the phosphate component (PO₄) in the slurry as calculated as PO₄ is, for example, at least 0.01% by mass but not more than 10% by mass. In view of reactivity of the phosphate component and productivity, the amount is preferably at least 0.05% by mass but not more than 5% by mass.

The aqueous phosphate solution may be prepared by mixing a phosphate compound with water. Examples of the phosphate compound include orthophosphoric acid, sodium dihydrogen phosphate, sodium monohydrogen phosphate, ammonium dihydrogen phosphate, ammonium monohydrogen phosphate, zinc phosphate, calcium phosphate, and other phosphates, hypophosphorous acid and hypophosphites, pyrophosphoric acid, polyphosphoric acid, and other inorganic phosphoric acids, and organic phosphoric acids, and salts thereof. These may be used alone or in combinations of two or more. Moreover, to improve the water resistance and corrosion resistance of the coating and the magnetic properties of the magnetic powder, additives may be added including, for example, oxoacid salts such as molybdates, tungstates, vanadates, and chromates; oxidizing agents such as sodium nitrate and sodium nitrite; and chelating agents such as EDTA.

The phosphate concentration (calculated as PO₄) in the aqueous phosphate solution is, for example, at least 5% by mass but not more than 50% by mass. In view of the solubility and storage stability of the phosphate compound and ease of chemical treatment, the concentration is preferably at least 10% by mass but not more than 30% by mass. The pH of the aqueous phosphate solution is, for example, at least 1 but not more than 4.5, and it is preferably at least 1.5 but not more than 4 to easily control the precipitation rate of the phosphate. The pH may be adjusted using dilute hydrochloric acid, dilute sulfuric acid, or the like.

In the phosphate treatment step, an inorganic acid is preferably added to adjust the pH of the slurry to at least 1 but not more than 4.5, more preferably at least 1.6 but not more than 3.9, still more preferably at least 2 but not more than 3. If the pH is less than 1, aggregation of the phosphate-coated SmFeN-based anisotropic magnetic powder particles tends to occur starting from the locally highly precipitated phosphate, resulting in a lower coercive force. If the pH is more than 4.5, the amount of the precipitated phosphate tends to decrease, resulting in an insufficient coating and thus a lower coercive force. Examples of the inorganic acid to be added include hydrochloric acid, nitric acid, sulfuric acid, boric acid, and hydrofluoric acid. In the phosphate treatment step, the inorganic acid may be added as needed to adjust the pH within the above-described range. Although the inorganic acid is used in view of liquid waste disposal, an organic acid may be used together depending on the purpose. Examples of the organic acid include acetic acid, formic acid, and tartaric acid. A mixture of the inorganic acid and the organic acid may also be used.

The phosphate treatment step may be performed such that the lower limit of the phosphate content of the resulting phosphate-coated anisotropic magnetic powder is higher than 0.1% by mass. The lower limit of the phosphate content of the phosphate-coated SmFeN-based anisotropic magnetic powder obtained in the phosphate treatment step is preferably 0.2% by mass or higher, particularly preferably 0.5% by mass or higher. The upper limit of the phosphate content is preferably 4.5% by mass or lower, more preferably 2.5% by mass or lower, particularly preferably 2% by mass or lower. If the phosphate content is 0.1% by mass or lower, the effect of the phosphate coating tends to be reduced. If the phosphate content is higher than 4.5% by mass, aggregation of the phosphate-coated SmFeN-based anisotropic magnetic powder particles tends to occur, resulting in a lower coercive force. Moreover, when the phosphate content is 0.5% by mass or higher, the hot water resistance of the resulting phosphate-coated anisotropic magnetic powder tends to be further improved. Here, the phosphate content of the magnetic powder is measured by ICP atomic emission spectroscopy (ICP-AES) and converted to a PO₄ molecule content.

The adjustment of the pH of the slurry containing the anisotropic magnetic powder, water, and a phosphate compound within the range of at least 1 but not more than 4.5 is preferably performed for at least 10 minutes. To reduce the thin parts of the coating portion, the adjustment is preferably performed for at least 30 minutes. In maintaining the pH, as the pH initially increases rapidly, the inorganic acid for pH control should be introduced at short intervals. Then, as the coating proceeds, the pH changes more gently, and thus the inorganic acid may be introduced at longer intervals, which allows one to determine the end point of the reaction.

### Oxidation Step

In the oxidation step, the obtained phosphate-coated anisotropic magnetic powder may be heat-treated at a high temperature of at least 200° C. but not higher than 250° C. in an oxygen-containing atmosphere. Thus, it is believed that the surface of the base material anisotropic magnetic powder coated with a phosphate may be oxidized to form a thick iron oxide layer, which improves the hot water resistance of the phosphate-coated anisotropic magnetic powder.

In the oxidation step, the phosphate-coated anisotropic magnetic powder obtained in the phosphate treatment step is preferably oxidized by heat-treating the powder at a temperature of at least 200° C. but not higher than 250° C. in an oxygen-containing atmosphere. When the phosphate-coated anisotropic magnetic powder is heat-treated at a high temperature of at least 200° C. but not higher than 250° C. in an oxygen-containing atmosphere, the surface of the base material anisotropic magnetic powder coated with a phosphate may be oxidized to form a thick iron oxide layer, which improves the hot water resistance of the phosphate-coated anisotropic magnetic powder.

The oxidation step may be performed by heat-treating the phosphate-coated SmFeN-based anisotropic magnetic powder in an oxygen-containing atmosphere. The reaction atmosphere preferably contains oxygen in an inert gas such as nitrogen or argon. The oxygen concentration is preferably at least 3% but not more than 21%, more preferably at least 3.5% but not more than 10%. During the oxidation reaction, gas exchange is preferably performed at a flow rate of at least 2 L/min but not higher than 10 L/min per kg of the magnetic powder.

The heat treatment temperature during the oxidation step is preferably at least 200° C. but not higher than 250° C., more preferably at least 210° C. but not higher than 230° C. If the temperature is lower than 200° C., the formation of an iron oxide layer tends to be insufficient, resulting in lower hot water resistance. If the temperature is higher than 250° C., the formation of an iron oxide layer tends to be excessive, resulting in a lower coercive force. The heat treatment time is preferably at least 3 hours but not longer than 10 hours.

In view of the coercive force of the phosphate-coated anisotropic magnetic powder, the thickness of the phosphate coating portion of the phosphate-coated anisotropic magnetic powder is preferably at least 10 nm but not more than 200 nm. Here, the thickness of the phosphate coating portion can be measured by composition analysis using an EDX line scan of a cross-section of the phosphate-coated anisotropic magnetic powder.

### Silica Treatment Step

The anisotropic magnetic powder obtained after the phosphate treatment may optionally be subjected to a silica treatment. The formation of a silica thin film on the magnetic powder may improve oxidation resistance. The silica thin film may be formed, for example, by mixing an alkyl silicate, the phosphate-coated anisotropic magnetic powder, and an alkali solution.

### Silane Coupling Treatment Step

The magnetic powder obtained after the silica treatment may be further treated with a silane coupling agent. When the magnetic powder provided with a silica thin film is subjected to a silane coupling treatment, a coupling agent film may be formed on the silica thin film, which may improve the magnetic properties of the magnetic powder as well as wettability between the magnetic powder and the resin and magnet strength. Any silane coupling agent may be used and may be selected depending on the type of resin. Examples of the silane coupling agent include 3-aminopropyltriethoxysilane, γ-(2-aminoethyl)aminopropyltrimethoxysilane, γ-(2-aminoethyl)aminopropylmethyldimethoxysilane, γ-methacryloxypropyltrimethoxysilane, γ-methacryloxypropylmethyldimethoxysilane, N-β-(N-vinylbenzylaminoethyl)-γ-aminopropyltrimethoxysilane hydrochloride, γ-glycidoxypropyltrimethoxysilane, γ-mercaptopropyltrimethoxysilane, methyltrimethoxysilane, methyltriethoxysilane, vinyltriacetoxysilane, γ-chloropropyltrimethoxysilane, hexamethylenedisilazane, γ-anilinopropyltrimethoxysilane, vinyltrimethoxysilane, octadecyl[β-(trimethoxysilyl)propyl]ammonium chloride, γ-chloropropylmethyldimethoxysilane, γ-mercaptopropylmethyldimethoxysilane, methyltrichlorosilane, dimethyldichlorosilane, trimethylchlorosilane, vinyltrichlorosilane, vinyltris(β-methoxyethoxy)silane, vinyltriethoxysilane, β-(3,4-epoxycyclohexyl)ethyltrimethoxysilane, γ-glycidoxypropylmethyldiethoxysilane, N-β-(aminoethyl)-γ-aminopropyltrimethoxysilane, N-β-(aminoethyl)-γ-aminopropylmethyldimethoxysilane, γ-aminopropyltriethoxysilane, N-phenyl-γ-aminopropyltrimethoxysilane, ureidopropyltriethoxysilane, γ-isocyanatopropyltriethoxysilane, polyethoxydimethylsiloxane, polyethoxymethylsiloxane, bis(trimethoxysilylpropyl)amine, bis(3-triethoxysilylpropyl)tetrasulfane, γ-isocyanatopropyltrimethoxysilane, vinylmethyldimethoxysilane, 1,3,5-N-tris(3-trimethoxysilylpropyl)isocyanurate, t-butyl carbamate trialkoxysilane, and N-(1,3-dimethylbutylidene)-3-(triethoxysilyl)-1-propaneamine. These silane coupling agents may be used alone or in combinations of two or more. The amount of the silane coupling agent added per 100 parts by mass of the magnetic powder is preferably at least 0.2 parts by mass but not more than 0.8 parts by mass, more preferably at least 0.25 parts by mass but not more than 0.6 parts by mass. If the amount is less than 0.2 parts by mass, the effect of the silane coupling agent tends to be small. If the amount is more than 0.8 parts by mass, the magnetic properties of the magnetic powder or magnet tend to decrease due to aggregation of the magnetic powder.

The anisotropic magnetic powder obtained after the phosphate treatment step, oxidation step, silica treatment, or silane coupling treatment may be filtered, dehydrated, and dried in a usual manner.

### Bonded Magnet Compound and Preparation Method Thereof

For example, the bonded magnet compound used in the cylindrical multipole magnet according to the present embodiments may contain the phosphate-coated SmFeN-based anisotropic magnetic powder and a resin such as polypropylene. The bonded magnet compound containing the phosphate-coated SmFeN-based anisotropic magnetic powder and polypropylene can be used to produce a bonded magnet with improved hot water resistance. Here, the bonded magnet compound can be prepared as described above.

The filling ratio of the anisotropic rare earth magnetic powder (the amount of the magnetic powder in the bonded magnet compound) is at least 50 vol % but not higher than 65 vol %, preferably at least 50 vol % but not higher than 60 vol %, more preferably at least 50 vol % but not higher than 58 vol %, still more preferably at least 51 vol % but not higher than 56 vol % with respect to the total volume of the anisotropic rare earth magnetic powder and the resin. When the filling ratio is not higher than 65 vol %, a decrease in the surface magnetic flux density of the cylindrical multipole bonded magnet having even a thin body tends to be reduced. When the filling ratio is at least 50 vol %, the proportion of the magnetic powder in the bonded magnet may be increased to further improve the surface magnetic flux density.

Examples of the resin include thermoplastic resins such as polyphenylene ether, polypropylene, polyethylene, polyvinyl chloride, polyester, polyamide, polycarbonate, polyphenylene sulfide, and acrylic resins. In view of water resistance, polypropylene having low hygroscopicity is preferred among these. Polymer alloys or resin mixtures of polypropylene and polyphenylene ether are more preferred to further provide hot water resistance. For example, a resin mixture prepared by adding polypropylene to polyphenylene ether may have a lower viscosity than polyphenylene ether alone, thereby improving the orientation of the cylindrical multipole magnet. A polymer alloy of polypropylene and polyphenylene ether may be prepared by a conventionally known method, and the preparation method is not limited. For example, when polyphenylene ether is used as an amorphous resin, exemplary methods include a method in which a polypropylene resin and a polyphenylene ether/polystyrene resin are separately melt-kneaded with a peroxide and maleic anhydride using a single screw or twin screw kneading extruder to allow the acid anhydride to be grafted to each resin, and the graft-modified resins are kneaded again with a diamine so that the structural components are bonded to each other by grafting; and a method in which a polypropylene resin and a polyphenylene ether/polystyrene alloy resin are kneaded with a compatibilizer. Examples of the compatibilizer used in the latter method include hydrogenated butadiene/styrene copolymers, styrene-ethylene/butylene-styrene block copolymers, styrene-ethylene/butylene-ethylene block copolymers, and ethylene-ethylene/butylene-ethylene block copolymers. The amount of the polypropylene resin in the polymer alloy may be adjusted within the range of, for example, at least 10% by mass but not more than 20% by mass, and the amount of the amorphous resin may be adjusted to, for example, at least 50% by mass but not more than 70% by mass. Moreover, the polymer alloy may be a commercial resin, examples of which include Xyron EV103 and Xyron T0702 (Asahi Kasei Chemicals Corporation) and Lemalloy PX603Y (Mitsubishi Chemical Corporation).

Resins including a first resin and a second resin are preferred. Moreover, the weight average molecular weight of the first resin is preferably smaller than the weight average molecular weight of the second resin. The weight average molecular weight of the first resin is preferably at least 1,000 but not more than 30,000, more preferably at least 5,000 but not more than 20,000. If the weight average molecular weight is more than 30,000, the difference from the molecular weight of the second resin tends to be reduced so that a great improvement in fluidity cannot be expected. If the weight average molecular weight is less than 1,000, the strength tends to decrease. Moreover, the weight average molecular weight of the second resin is preferably at least 50,000 but not more than 300,000, more preferably at least 50,000 but not more than 200,000, still more preferably at least 50,000 but not more than 150,000. If the weight average molecular weight is more than 300,000, fluidity tends to deteriorate, resulting in difficulty in orientation. If the weight average molecular weight is less than 50,000, the difference from the molecular weight of the first resin tends to be reduced to reduce the total molecular weight of the first and second resins, thereby making it difficult to form a bonded magnet. Here, the weight average molecular weight can be measured by gel permeation chromatography (GPC). The first resin having a smaller weight average molecular weight is preferably polypropylene having a weight average molecular weight of at least 1,000 but not more than 30,000, while the second resin having a larger weight average molecular weight is preferably polypropylene having a weight average molecular weight of at least 150,000 but not more than 300,000.

Moreover, the resins more preferably include a resin having a higher glass transition temperature (Tg) as a third resin. The glass transition temperature of the third resin is preferably higher than those of the first and second resins, and it is preferably 100° C. or higher. The glass transition temperature may be 250° C. or lower. The third resin having a glass transition temperature of 100° C. or higher tends to further improve hot water resistance even in use at high temperatures. The third resin having a glass transition temperature of 250° C. or lower can reduce the deterioration in the magnetic properties of the bonded magnet including the third resin. Here, the glass transition temperature can be measured with a differential scanning calorimeter (DSC). The third resin is preferably polyphenylene ether or a modified polyphenylene ether obtained by adding polypropylene or other resin.

In addition to the anisotropic rare earth magnetic powder and the resin, a thermoplastic elastomer and/or an antioxidant such as a phosphorus antioxidant or a phenolic antioxidant may be kneaded at the same time. When a thermoplastic elastomer is present, the mass ratio of polypropylene and the thermoplastic elastomer is preferably in the range of 90:10 to 50:50. In view of impact resistance, the mass ratio is more preferably in the range of 89:11 to 70:30. Moreover, when an antioxidant such as a phosphorus antioxidant or a phenolic antioxidant is present, the total amount of antioxidants is preferably at least 0.1% by mass but not more than 2% by mass of the amount of the magnetic powder in the bonded magnet compound. The presence of a phosphorus antioxidant can reduce the changes in strength over time, even when the composite material is exposed to high temperatures. Examples of the phosphorus antioxidant include tris(2,4-di-tert-butylphenyl)phosphite.

The amount of the first resin is preferably more than 0% by mass but not more than 60% by mass, more preferably at least 15% by mass but not more than 50% by mass based on the total amount of the first and second resins. When the amount of the first resin is not more than 60% by mass based on the total amount of the first and second resins, the molding of even a thin cylindrical multipole magnet tends to be facilitated. Moreover, when the first resin is present, or in other words, when the amount of the first resin is more than 0% by mass based on the total amount of the first and second resins, the thin cylindrical multipole magnet tends to have a much higher surface magnetic flux density. When the third resin is present, the amount of the third resin is preferably at least 1% by mass but not more than 20% by mass, more preferably at least 5% by mass but not more than 15% by mass based on the total amount of the first, second, and third resins. When the amount of the third resin is within the range indicated above, the advantageous effect of the present disclosure caused by a combination of the first and second resins tends to be greater.

### Cylindrical Multipole Magnet and Production Method Thereof

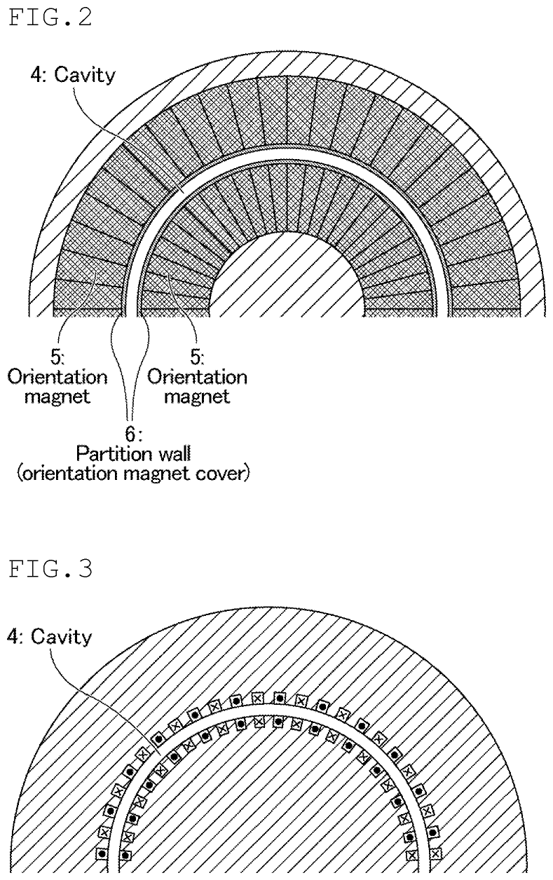

The cylindrical multipole magnet according to the present embodiments may be produced by injection-molding and magnetizing the bonded magnet compound containing the anisotropic rare earth magnetic powder and the resin. FIG. 2 shows a cross-sectional view of an exemplary mold that may be used in the injection molding. In the injection molding, an orientation step may be performed which includes applying an orientation field under heat treatment. For example, the heat treatment temperature in the orientation step is preferably at least 90° C. but not higher than 200° C., more preferably at least 100° C. but not higher than 150° C. Moreover, the magnitude of the orientation field in the orientation step may be 720 kA/m, for example. In this mold, orientation magnets 5 are disposed on both the inner and outer sides of a cavity 4, and the number of orientation magnets 5 provided corresponds to the actual number of poles of the cylindrical multipole magnet. To obtain a cylindrical multipole magnet having high magnetic properties, even when it has a large number of poles and a narrow NS pitch, orientation magnets are preferably disposed on both the inner and outer peripheral sides. A partition wall 6 is disposed on the cavity 4 side of each orientation magnet 5 to cover the orientation magnet 5 to prevent its direct contact with the resin. The thickness of the partition wall 6 is not limited, but it is preferably 0.7 mm or less, more preferably 0.5 mm or less. If the thickness is more than 0.7 mm, the orientation field tends not to reach the cavity, making it difficult to obtain a sufficient orientation field. The partition wall may also have a thickness of 0.01 mm or more, preferably 0.05 mm or more. If the thickness of the partition wall is less than 0.01 mm, a magnet with desired dimensions tends not to be obtained as the cavity may deform.

The cylindrical multipole magnet according to the present embodiments may be obtained by performing pulse magnetization in a magnetizing field after the orientation step. In the magnetization step, a magnetizing coil is preferably disposed on both the inner and outer peripheral sides of the cylindrical multipole magnet. FIG. 3 shows a cross-sectional view of such a magnetizing yoke. The magnitude of the magnetizing field in the magnetization step may be at least 800 kA/m but not more than 2000 kA/m, for example.

The cylindrical multipole magnet according to embodiments of the present disclosure may be suitably used in small motors, electric expansion valves for refrigerant valves, etc.

### EXAMPLES

Embodiments of the present disclosure are more specifically described with reference to examples below, but they are not limited by the examples.

The following materials were used in the examples.

Magnetic powder: a SmFeN-based anisotropic magnetic material (average particle size 3 μm)

First resin: polypropylene (weight average molecular weight 9,000)

Second resin: polypropylene (weight average molecular weight 90,000)

Third resin: a polymer alloy of polypropylene and polyphenylene ether (glass transition temperature 210° C.)

Additive A: a phenolic antioxidant

Additive B: a phosphorus antioxidant

### Production Example 1 (Including Phosphate Treatment Step Accompanied by pH Adjustment, and Oxidation Step)

### Phosphate Treatment Step

A phosphate treatment liquid was prepared by mixing 85% orthophosphoric acid, sodium dihydrogen phosphate, and sodium molybdate dihydrate at a mass ratio of 1:6:1, respectively, and adding pure water and dilute hydrochloric acid to adjust the pH and the PO₄ concentration to 2 and 20% by mass, respectively. To a slurry containing 1000 g of the SmFeN-based anisotropic magnetic powder was added dilute hydrochloric acid containing 70 g of hydrogen chloride, and they were stirred for one minute to remove the oxidized surface film and contaminants, followed by repeating draining and filling of water until the supernatant had a conductivity of 100 μS/cm or lower. Thus, a slurry containing 10% by mass of the SmFeN-based anisotropic magnetic powder was obtained. While stirring the slurry, 100 g of the prepared phosphate treatment liquid was entirely introduced into the treatment tank, and then the phosphating reaction slurry was maintained for 30 minutes while introducing 6% by mass hydrochloric acid as needed to control the pH of the slurry within the range of 2.5±0.1. Subsequently, the slurry was subjected to suction filtration, dehydration, and vacuum drying to obtain a phosphate-coated SmFeN-based anisotropic magnetic powder.

### Oxidation Step

The temperature of 1000 g of the phosphate-coated SmFeN-based anisotropic magnetic powder was gradually raised in an atmosphere of a gas mixture of nitrogen and air (oxygen concentration: 4%, 5 L/min) from room temperature to a maximum temperature of 230° C., at which heat treatment was performed for eight hours to obtain an oxidized phosphate-coated SmFeN-based anisotropic magnetic powder.

### Silica Treatment Step

The obtained magnetic powder, ethyl silicate 40, and 12.5% by mass ammonia water were mixed at a mass ratio of 97.8:1.8:0.4, respectively, in a mixer. The mixture was heated at 200° C. in vacuum to obtain a SmFeN-based anisotropic magnetic powder with a silica thin film formed on the particle surface.

### Silane Coupling Treatment Step

The obtained SmFeN-based anisotropic magnetic powder with a silica thin film and 12.5% by mass ammonia water were mixed in a mixer. Then, the mixture was mixed with a solution of 50% by mass 3-aminopropyltriethoxysilane in ethanol in the mixer. The mass ratio of the SmFeN-based anisotropic magnetic powder with a silica thin film, the 12.5% by mass ammonia water, and the solution of 3-aminopropyltriethoxysilane in ethanol was 99:0.2:0.8, respectively. This mixture was dried in a nitrogen atmosphere at 100° C. for 10 hours to obtain a silane coupling-treated SmFeN-based anisotropic magnetic powder.

### Production Example 2 (Including Phosphate Treatment Step Accompanied by pH Adjustment, and No Oxidation Step)

A phosphate-coated SmFeN-based anisotropic magnetic powder was obtained as in Production Example 1, except that the oxidation step was not performed.

### Production Example 3 (Including Phosphate Treatment Step Accompanied by No pH Adjustment, and Oxidation Step)

A phosphate-coated SmFeN-based anisotropic magnetic powder was obtained as in Production Example 1, except that 6% by mass hydrochloric acid was not introduced as needed to control the pH of the phosphating reaction slurry within the range of 2.5±0.1 in the phosphate treatment step.

### Production Example 4 (Including Phosphate Treatment Step Accompanied by No pH Adjustment, and No Oxidation Step)

A phosphate-coated SmFeN-based anisotropic magnetic powder was obtained as in Production Example 1, except that 6% by mass hydrochloric acid was not introduced as needed to control the pH of the phosphating reaction slurry within the range of 2.5±0.1 in the phosphate treatment step, and the oxidation step was not performed.

### Particle Size Distribution

The particle size distribution was measured with a laser diffraction particle size distribution analyzer (HELOS & RODOS, Japan Laser Corporation). Table 1 shows the measurement results.

### Exothermic Onset Temperature

The exothermic onset temperatures of the magnetic powders produced in Production Examples 1 to 4 were measured by weighing 20 mg of each magnetic powder and subjecting it to DSC analysis using a high-temperature differential scanning calorimeter (DSC 6300, Hitachi High-Tech Science Corporation) under measurement conditions including an air atmosphere (200 mL/min), a temperature rise from room temperature to 400° C. (rate of temperature rise: 20° C./min), and alumina (20 mg) as reference. Table 1 shows the exothermic onset temperatures. A higher exothermic onset temperature indicates less heat generated by oxidation, meaning that a denser phosphate coating is formed. Table 1 shows the measurement results.

TABLE 1

| | pH | | Properties of magnetic powder | | | | | | | |
|---|---|---|---|---|---|---|---|---|---|---|
| | adjustment | | | | | Particle | | DSC exothermic | | Total |
| | during | | | | | size | Amount of | onset | α-Fe peak | carbon |
| | phosphate | Oxidation | D10 | D50 | D90 | distribution | attached PO₄ | temperature | height ratio | content |
| | treatment | step | μm | μm | μm | D90/D10 | wt % | ° C. | (110/300) | TC ppm |
| Production | Yes | Yes | 1.60 | 3.25 | 5.22 | 3.26 | 1.0 | 288 | 34 | 280 |
| Example 1 | | | | | | | | | | |
| Production | Yes | No | 1.59 | 3.24 | 5.15 | 3.24 | 1.0 | 210 | 41 | 280 |
| Example 2 | | | | | | | | | | |
| Production | No | Yes | 1.67 | 3.32 | 5.43 | 3.25 | 0.5 | 215 | 208 | 280 |
| Example 3 | | | | | | | | | | |
| Production | No | No | 1.63 | 3.28 | 5.22 | 3.20 | 0.5 | 165 | 229 | 280 |
| Example 4 | | | | | | | | | | |

### Production Examples 5 to 13

The first resin, the second resin, the third resin, the additive A, the additive B, and one of the magnetic powders produced in Production Examples 1 to 4 were mixed in a mixer. Then, the mixture was introduced into a twin screw kneader and kneaded at 210° C. to obtain a bonded magnet compound. The blending ratio of the first, second, and third resins is as shown in Table 2 or 3, and the additives A and B were mixed in amounts of 0.3% by mass and 0.2% by mass, respectively, of the amount of the magnetic powder.

### Injection Pressure

The bonded magnet compounds prepared in Production Examples 5 to 13 were each injection-molded at a cylinder temperature of 240° C., a mold temperature of 90° C., and an orientation field of 9 kOe. Each molded article was magnetized by an air core coil in a magnetic field of 60 kOe to prepare a test piece of a bonded magnet 1 for evaluation with a diameter of 10 mm and a height of 7 mm. Tables 2 and 3 show the injection pressure during the injection molding.

Separately, the bonded magnet compounds prepared in Production Examples 6 and 9 to 13 were each injection-molded at a cylinder temperature of 240° C. and a mold temperature of 90° C. using a mold in which orientation magnets were longitudinally provided at NS intervals of 2 mm. Each molded article was magnetized by magnetizing yokes provided at NS intervals of 2 mm, thereby producing a flat multipole bonded magnet 2 for evaluation with a length of 45 mm, a width of 10 mm, and a height of 2 mm. Table 3 shows the injection pressure during the injection molding.

### Residual Magnetic Flux Density Br and Surface Magnetic Flux Density

The residual magnetic flux densities Br of the bonded magnets 1 for evaluation produced from the bonded magnet compounds prepared in Production Examples 5 to 13 were measured with a BH tracer. Tables 2 and 3 show the results. Moreover, the surface magnetic flux densities of the bonded magnets 2 for evaluation produced from the bonded magnet compounds prepared in Production Examples 6 and 9 to 13 were measured with a magnet analyzer. Table 3 shows the results.

### Time to Reach 5% Demagnetization

The dirt and oil on the magnet surface of each of the bonded magnets 1 for evaluation produced in Production Examples 5 to 8 were wiped out. Then, each bonded magnet was introduced into a pressure-resistant container together with a sufficient amount of water to immerse the entire magnet and kept in an oven at 120° C. for a predetermined time. The irreversible demagnetization rate was determined based on the change in total flux of the magnet before and after 1000 hours of the test. Here, the total flux was determined by placing the cylindrical multipole magnet inside a search coil, pulling the magnet out of the search coil, and measuring the change in magnetic flux inside the search coil using a fluxmeter (Nihon Denji Sokki Co., Ltd., model: NFX-1000), and the irreversible demagnetization rate was calculated using the following equation:

Irreversible demagnetization rate (%)=(Total flux at 0 hr−Total flux after predetermined time)/Total flux at 0 hr×100.

Table 2 shows the time when the irreversible demagnetization rate reached 5%.

TABLE 2

| | Magnetic powder/resin mixture | | | | | Bonded magnet 1 for evaluation | | |
|---|---|---|---|---|---|---|---|---|
| | Magnetic | | Ratio of mixed resins | | | | Residual | Water resistance |
| | powder | | First | Second | Third | Injection | magnetic | Time to reach 5% |
| | filling ratio | Magnetic | resin | resin | resin | pressure | flux density | demagnetization |
| | (vol %) | powder | (wt %) | (wt %) | (wt %) | (MPa) | Br (T) | (hr) |
| Production | 55 | Production | 50 | 40 | 10 | 43 | 0.71 | 200 |
| Example 5 | | Example 4 | | | | | | |
| Production | 55 | Production | 50 | 40 | 10 | 28 | 0.72 | 500 |
| Example 6 | | Example 3 | | | | | | |
| Production | 55 | Production | 50 | 40 | 10 | 43 | 0.71 | 240 |
| Example 7 | | Example 2 | | | | | | |
| Production | 55 | Production | 50 | 40 | 10 | 35 | 0.70 | >1000 |
| Example 8 | | Example 1 | | | | | | |

As demonstrated by Table 2, the bonded magnet of Production Example 8 including the magnetic powder of Production Example 1 had particularly high water resistance while maintaining a high residual magnetic flux density. It was found that, when pH adjustment is performed in the phosphate treatment step and the obtained magnetic powder is oxidized, the time to reach 5% demagnetization is increased and hot water resistance is greatly improved.

TABLE 3

| | | | | | | Bonded magnet 1 for | | Bonded magnet 2 for | |
|---|---|---|---|---|---|---|---|---|---|
| | Magnetic powder/resin mixture | | | | | evaluation | | evaluation | |
| | Magnetic | | Ratio of mixed resins | | | | Residual | | Surface |
| | powder | | First | Second | Third | Injection | magnetic flux | Injection | magnetic flux |
| | filling ratio | Magnetic | resin | resin | resin | pressure | density Br | pressure | density |
| | (vol %) | powder | (wt %) | (wt %) | (wt %) | (MPa) | (T) | (MPa) | (mT) |
| Production | 55 | Production | 50 | 40 | 10 | 28 | 0.72 | 39 | 221 |
| Example 6 | | Example 3 | | | | | | | |
| Production | 55 | Production | 30 | 60 | 10 | 38 | 0.71 | 53 | 206 |
| Example 9 | | Example 3 | | | | | | | |
| Production | 55 | Production | 15 | 75 | 10 | 52 | 0.70 | 73 | 194 |
| Example 10 | | Example 3 | | | | | | | |
| Production | 55 | Production | 0 | 90 | 10 | 69 | 0.71 | 96 | 187 |
| Example 11 | | Example 3 | | | | | | | |
| Production | 51 | Production | 30 | 60 | 10 | 36 | 0.65 | 53 | 212 |
| Example 12 | | Example 3 | | | | | | | |
| Production | 59 | Production | 30 | 60 | 10 | 74 | 0.77 | 106 | 186 |
| Example 13 | | Example 3 | | | | | | | |

From the results in Table 3, the magnets produced in Production Examples 9, 12, and 13 as non-thin bonded magnets 1 for evaluation showed an increase in injection pressure but no significant difference in residual magnetic flux density as the magnetic powder filling ratio increased. On the other hand, as thin bonded magnets 2 for evaluation, they showed a decrease in surface magnetic flux density when the amount of the magnetic powder filled was increased to a filling ratio of 59%. These results indicate that for a thin multipole magnet including an anisotropic magnetic powder, increasing the magnetic powder filling ratio does not result in higher magnetic properties, but the fluidity of a magnetic powder/resin mixture in which the magnetic powder is mixed with a resin affects the magnetic properties of the resulting bonded magnet. Moreover, the evaluation results of the plate-like multipole magnets produced in Production Examples 6, 9, 10, and 11 show that an increase in the amount of a first resin with a low molecular weight results in improved fluidity and enhanced surface magnetic flux density.

### Examples 1 to 12

### Injection Molding Step

Injection molding was performed using a mold as shown in FIG. 2 in which the distance between the cavity 4 and the orientation magnet 5 (the thickness of the partition wall 6) was 0.3 mm, and twenty-four orientation magnets 5 were arranged. The bonded magnet compounds prepared in Production Examples 5 to 12 were each heated to 240° C. in the barrel of an injection molding machine and then injection-molded in the mold controlled at a temperature of 90° C. while applying a magnetic field of 9 kOe for orientation. Each injection-molded bonded magnet was magnetized using a mold as shown in FIG. 3. Magnetizing yokes were arranged on the inner and outer peripheries. The magnetization was carried out at 1800 kV (capacitance: 1000 g). Thus, cylindrical multipole magnet molded articles of Examples 1 to 9 having an outer diameter of 39 mm, an inner diameter of 36 mm, and a height of 10 mm were obtained.

### Back Yoke Arrangement Step

A back yoke made of SUS430 (material) with an outer diameter of 43 mm, an inner diameter of 39 mm, and a height of 10 mm was prepared. The back yoke was contacted and fitted with the outer peripheral surface of each cylindrical multipole magnet molded article obtained in the molding step. Thus, composite materials including the cylindrical multipole magnets of Examples 1 to 9 were prepared. Moreover, magnets prepared as in Example 1, except for the preparation conditions shown in Table 4, were simulated as Examples 10 to 12. Table 4 shows the simulation results. The simulation was carried out using the information on Production Example 6 and an electromagnetic field analysis software (JMAG™, JSOL Corporation).

### Comparative Examples 1 to 4

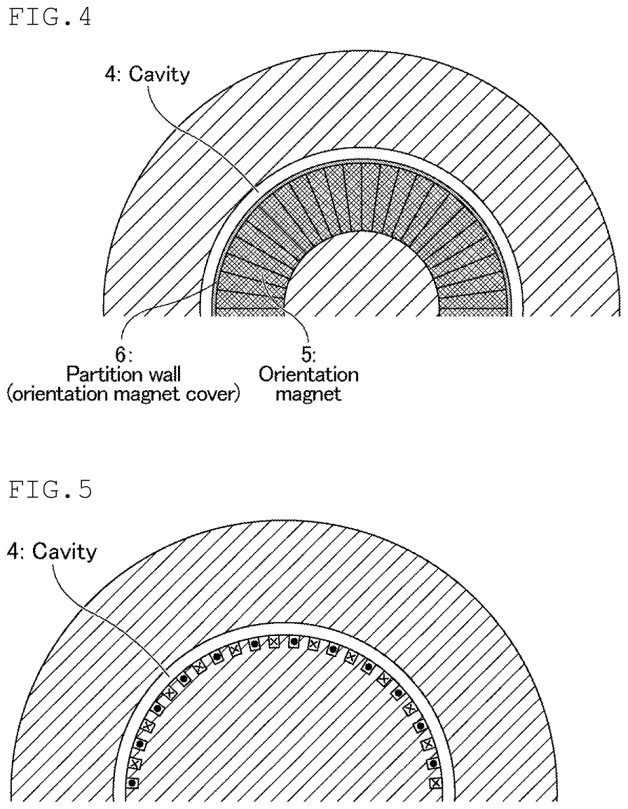

Injection molding was performed as in Examples 1 to 12, except that a mold as shown in FIG. 4 was used, twenty-four orientation magnets 5 were arranged on the inner periphery, and no orientation magnet was arranged on the outer periphery. Moreover, magnetization was performed by magnetizing yokes provided only on the inner peripheral side using a mold as shown in FIG. 5. Moreover, a back yoke arrangement step was performed as in Examples 1 to 12. Separately, magnets prepared as in Comparative Example 1, except for the preparation conditions shown in Table 4, were simulated as Comparative Examples 2 to 4. Table 4 shows the simulation results.

### Surface Magnetic Flux Density

The surface magnetic flux densities (mT) of the cylindrical multipole magnets produced in the examples and comparative examples were measured with a magnet analyzer. Table 4 shows the measurement results.

TABLE 4

| | | | | | | | Evaluation of BY-integrated cylindrical multipole magnet |
|---|---|---|---|---|---|---|---|
| | | | | | | | Without BY (cylindrical multipole magnet) |
| | Preparation conditions | | | | | | Surface magnetic |
| | | | | Outer | Inner | | flux density on |
| | | Orientation | Number | diameter | diameter | Thickness | outer peripheral |
| | Compound | method | of poles | (mm) | (mm) | (mm) | side (mT) |
| Example 1 | Production | Sandwiched | 48 | 39.0 | 36.0 | 1.5 | 168 |
| | Example 5 | | | | | | |
| Example 2 | Production | Sandwiched | 48 | 39.0 | 36.0 | 1.5 | 225 |
| | Example 6 | | | | | | |
| Example 3 | Production | Sandwiched | 48 | 39.0 | 36.0 | 1.5 | 209 |
| | Example 7 | | | | | | |
| Example 4 | Production | Sandwiched | 48 | 39.0 | 36.0 | 1.5 | 220 |
| | Example 8 | | | | | | |
| Example 5 | Production | Sandwiched | 48 | 39.0 | 36.0 | 1.5 | 220 |
| | Example 9 | | | | | | |
| Example 6 | Production | Sandwiched | 48 | 39.0 | 36.0 | 1.5 | 201 |
| | Example 10 | | | | | | |
| Example 7 | Production | Sandwiched | 48 | 39.0 | 36.0 | 1.5 | 197 |
| | Example 11 | | | | | | |
| Example 8 | Production | Sandwiched | 48 | 39.0 | 36.0 | 1.5 | 218 |
| | Example 12 | | | | | | |
| Example 9 | Production | Sandwiched | 48 | 39.0 | 36.0 | 1.5 | 192 |
| | Example 13 | | | | | | |
| Comparative | Production | Only inner | 48 | 39.0 | 36.0 | 1.5 | 15 |
| Example 1 | Example 6 | periphery | | | | | |
| Example 10 | Production | Sandwiched | 48 | 18.5 | 16.5 | 1.0 | 169 |
| | Example 6 | | | | | | |
| Comparative | Production | Only inner | 48 | 18.5 | 16.5 | 1.0 | 20 |
| Example 3 | Example 6 | periphery | | | | | |
| Example 11 | Production | Sandwiched | 24 | 18.5 | 16.5 | 1.0 | 190 |
| | Example 6 | | | | | | |
| Comparative | Production | Only inner | 24 | 18.5 | 16.5 | 1.0 | 20 |
| Example 2 | Example 6 | periphery | | | | | |
| Example 12 | Production | Sandwiched | 64 | 18.5 | 16.5 | 1.0 | 164 |
| | Example 6 | | | | | | |
| Comparative | Production | Only inner | 64 | 18.5 | 16.5 | 1.0 | 18 |
| Example 4 | Example 6 | periphery | | | | | |

| | Evaluation of BY-integrated cylindrical multipole magnet | | | |
|---|---|---|---|---|
| | Without BY (cylindrical multipole magnet) | | | |
| | | Surface magnetic | With BY | |
| | Surface magnetic | flux density ratio | Surface magnetic | Surafce magnetic |
| | flux density on | Outer peripheral | flux density on | flux density on |
| | inner peripheral | side/Inner | outer peripheral | inner peripheral |
| | side (mT) | peripheral side | side (mT) | side (mT) |
| Example 1 | 173 | 0.97 | 0.6 | 202 |
| Example 2 | 229 | 0.98 | 0.7 | 260 |
| Example 3 | 212 | 0.99 | 0.6 | 244 |
| Example 4 | 225 | 0.98 | 0.9 | 253 |
| Example 5 | 223 | 0.99 | 0.7 | 254 |
| Example 6 | 207 | 0.97 | 0.5 | 238 |
| Example 7 | 200 | 0.99 | 0.7 | 231 |
| Example 8 | 223 | 0.98 | 0.8 | 250 |
| Example 9 | 197 | 0.97 | 0.9 | 227 |
| Comparative | 140 | 0.11 | 0.1 | 180 |
| Example 1 | | | | |
| Example 10 | 181 | 0.93 | 0.0 | 217 |
| Comparative | 168 | 0.12 | 0.0 | 168 |
| Example 3 | | | | |
| Example 11 | 207 | 0.92 | 0.0 | 272 |
| Comparative | 180 | 0.11 | 0.0 | 180 |
| Example 2 | | | | |
| Example 12 | 162 | 1.01 | 0.0 | 165 |
| Comparative | 132 | 0.14 | 0.0 | 132 |
| Example 4 | | | | |

As shown in Table 4, all the cylindrical multipole magnets orientated while being sandwiched had a thin body and exhibited a sufficient surface magnetic flux density even though they had as many as 24 poles.

The cylindrical multipole magnet according to embodiments of the present disclosure has an excellent surface magnetic flux density and thus can be used in various applications such as small motors.

What is claimed is:

1. A cylindrical multipole magnet, having an inner peripheral surface and an outer peripheral surface and having N- and S-poles alternately and continuously in a circumferential direction,
wherein a surface magnetic flux density of the outer peripheral surface is at least 0.2 times a surface magnetic flux density of the inner peripheral surface,
wherein the cylindrical multipole magnet comprises an anisotropic rare earth magnetic powder and a resin, with a filling ratio of the anisotropic rare earth magnetic powder being at least 50 vol % but not higher than 65 vol % with respect to a total volume of the anisotropic rare earth magnetic powder and the resin.

2. The cylindrical multipole magnet according to claim 1,
wherein the cylindrical multipole magnet has at least 16 but not more than 64 magnetic poles.

3. The cylindrical multipole magnet according to claim 1,
wherein a difference between an outer diameter of the cylindrical multipole magnet and an inner diameter of the cylindrical multipole magnet is at least 1.0 mm but not more than 8.0 mm.

4. The cylindrical multipole magnet according to claim 1,
wherein the resin comprises a first resin having a weight average molecular weight that is at least 1,000 but not more than 30,000 and a second resin having a weight average molecular weight that is at least 50,000 but not more than 300,000.

5. The cylindrical multipole magnet according to claim 4,
wherein an amount of the first resin is more than 0% by mass but not more than 60% by mass based on a total amount of the first resin and the second resin.

6. The cylindrical multipole magnet according to claim 1,
wherein the anisotropic rare earth magnetic powder has an exothermic onset temperature of 170° C. or higher as measured by differential scanning calorimetry.

7. The cylindrical multipole magnet according to claim 1,
wherein the anisotropic rare earth magnetic powder comprises a nitride containing samarium and iron.

8. The cylindrical multipole magnet according to claim 1,
wherein the anisotropic rare earth magnetic powder has a particle size distribution of 4.5 or less, wherein the particle size distribution represents a ratio of a 90th percentile particle size (D90) to a 10th percentile particle size (D10) in a cumulative particle size distribution by volume (D90/D10).

9. A composite material, comprising the cylindrical multipole magnet according to claim 1 and a back yoke fixed to the inner peripheral surface or the outer peripheral surface of the cylindrical multipole magnet.

10. The composite material according to claim 9,
wherein the back yoke is fixed to the outer peripheral surface of the cylindrical multipole magnet.
